(19) United States
(12) Patent Application Publication
(10) Pub. No.: US 2009/0300737 A1
(43) Pub. Date: Dec. 3, 2009

(54) SPLIT TEMPLATE BIOMETRIC VERIFICATION SYSTEM

(76) Inventor: Jeffrey L. Crandell, Hermosa Beach, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/472,084

(22) Filed: May 26, 2009

Related U.S. Application Data
(60) Provisional application No. 61/056,182, filed on May 27, 2008.

(51) Int. Cl. G06F 17/30; H04L 9/32

(52) U.S. Cl. 726/5; 707/10; 707/E17.005; 707/E17.009

(57) ABSTRACT

An exemplary system includes a plurality of storage devices storing at least one of a plurality of chunks of a template. A first chunk is stored in a first location and a second chunk is stored in a second location. The system further includes a client device in communication with the storage devices. Each client device includes a verification module that divides the template into the plurality of chunks, and reconstitutes the plurality of chunks into the template during validation. A method includes generating the template based upon an enrollment biometric identifier, dividing the template into the plurality of chunks, storing at least one of the plurality of chunks in a first storage location, and storing at least another of the plurality of chunks in a second storage location.

### CROSS-REFERENCE TO RELATED APPLICATIONS

This application claims the benefit of application Ser. No. 61/056,182 filed on May 27, 2008, the contents of which are incorporated herein in their entirety.

### TECHNICAL FIELD

The present disclosure relates to biometric authentication, and more particularly to protecting a biometric template used to validate a credential.

### BACKGROUND

Biometric authentication involves the process of scanning biometric attributes such as fingerprints, palm prints, retina patters, facial shapes, voice signatures, etc. The scan of the attribute may then be compared against a previously obtained scan of the same attribute. An individual may be authenticated if the current scan of the biometric attribute corresponds to the previously obtained scan. However, it may be possible to defeat a biometric authentication system by replicating or manipulating the previously scanned data. Additionally, an analysis of the previously scanned data may reveal sensitive information of the individual that provided the data. Accordingly, biometric authentication systems may be enhanced by protecting the previously scanned data

### BRIEF DESCRIPTION OF THE DRAWINGS

Exemplary illustrations of the disclosure will now be described, by way of example, with reference to the accompanying drawings, wherein:

FIG. 1a is an exemplary data flow diagram illustrating the biometric template data;

FIG. 1b is a system diagram of an exemplary split template biometric verification system;

FIG. 1c is an exemplary data entity diagram depicting a chunk storage map;

FIG. 2a is an exemplary removable data storage unit attached to a client computer system;

FIG. 2b is an exemplary removable data storage unit incorporating a biometric reader;

FIG. 2c is an exemplary removable data storage unit with an exposed controller and storage medium;

FIG. 3 is a flowchart depicting exemplary steps and decisions related to splitting a template; and

FIG. 4 is a flowchart depicting exemplary steps and decisions related to reconstituting a template.

### DETAILED DESCRIPTION

Exemplary illustrations of a split template biometric verification system are described below. In the interest of clarity, not all features of an actual implementation are described in this specification. It will of course be appreciated that in the development of any such actual illustration, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

Referring now to the drawings wherein like numerals indicate like or corresponding parts throughout the several views, exemplary embodiments are illustrated.

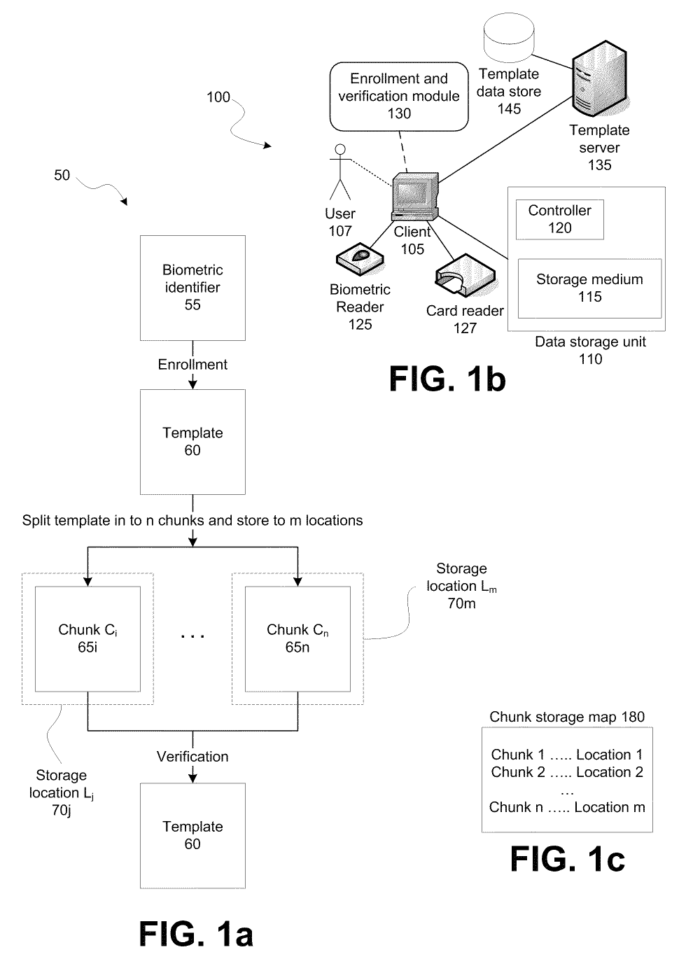

FIG. 1a is an exemplary data flow diagram 50 illustrating biometric verification data from the origination thereof as a biometric identifier 55, the conversion thereof to a template 60, the division thereof into a plurality of chunks 65i-n, and the reconstitution thereof into the template 60. The biometric identifier 55, e.g., fingerprints, palm prints, retina patterns, facial shapes, voice signatures, etc., may be scanned by a biometric reader 125 (FIG. 1b). An initial scan of the biometric identifier 55 may be referred to as an enrollment. The enrollment procedure may produce the template 60 from the scan of the biometric identifier 55. In one exemplary approach, the template 60 may include the raw data from scanning the biometric identifier 55. However, in another exemplary approach, the raw data may be converted or reduced into the template 60 having a more convenient or useful form. For example, the template 60 may include a mathematical representation that maps out key details and points of the biometric identifier 55. Further, the template 60 may provide a normalized representation of the biometric identifier 55, which may be more suitable for later comparisons.

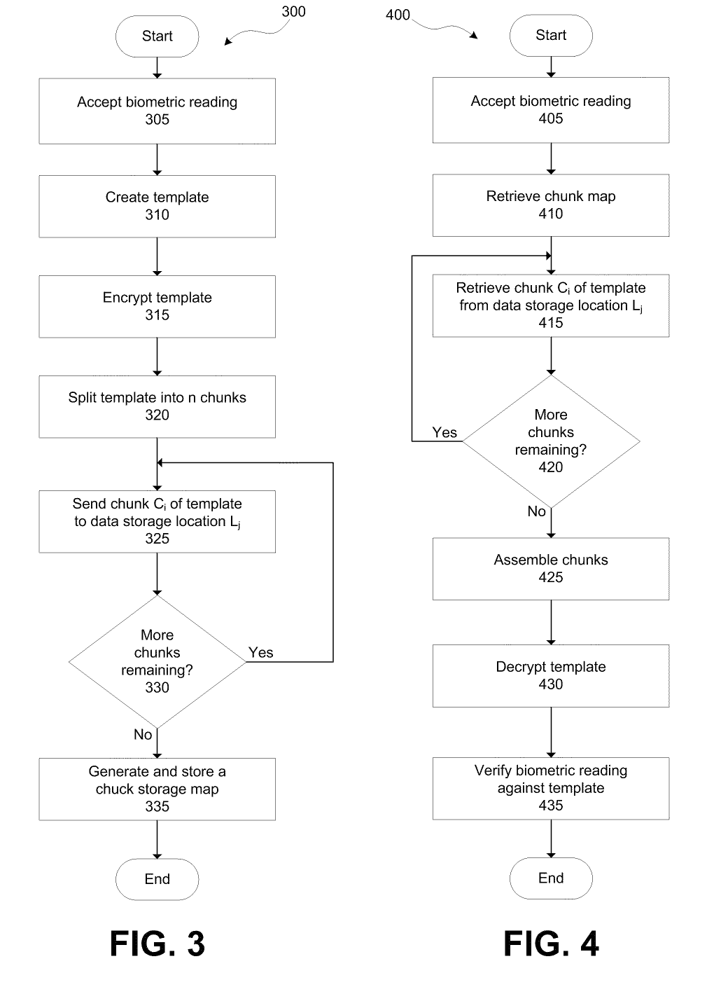

The template 60 provides a representation of the biometric identifier 55 that could potentially be used to defeat a biometric authentication system. Accordingly, the template 60 is a sensitive data element that should be secured against improper disclosure, reproduction, or manipulation. To secure the template 60, it may be divided or split into multiple chunks 65i-n. Each chunk 65i-n may provide little, if any, information about the original biometric identifier 55. The chunks 65i-n may be stored to a plurality of storage locations 70j-m. In one exemplary approach, each chunk 65i-n may be stored to a different storage location 70j-m. However, in another exemplary approach, the chunks a plurality of chunks 65i-n may be stored to a single storage location 70j-m, and in a modification to this approach at least one chunk may be stored to a separate storage location. For example, less than all of the chunks may be stored in the first storage location 70j while any chunks not stored in the first storage location may be stored in the second storage location 70m. The process of splitting the template 60 and storing the chunks 65i-n will be discussed in more detail below with respect to FIG. 3. Likewise, the process of reconstituting the template 60 from the chunks 65i-n will be discussed below with respect to FIG. 4.

The template 60 may be split into chunks 65i-n according to numerous different schemes. However, any scheme should be mindful of the underlying data structure of the template to ensure that no single chunk reveals crucial information about the biometric identifier 55. In one exemplary approach, the chunks 65i-n may be of equal size. However, in another exemplary approach, the chunks 65i-n may differ in size. For example, a critical, yet small, portion of the template 60 may be split off as a first chunk 65i leaving the remainder as a second chunk 65n. The small chunk 65i may be suitable for storage as a bar code or other encoding medium with limited capacity, while the larger chunk 65n may be stored on a server.

FIG. 1b illustrates an exemplary split template biometric verification system 100. The system 100 may include a client 105, which may be operated by a user 107, connected to a data storage unit 110. The data storage unit 110 may include a storage medium 115 accessible through a controller 120. A biometric reader 125 may be provided to scan a biometric identifier 55 as a credential during both the enrollment and validation procedures. A card reader 127 may be configured to store a template chunk 65i to a removable card. An enrollment and verification module 130 may be configured to split the template 60 into multiple chucks 65i-n during enrollment and reconstitute the chucks 65i-n during validation. The template server 135 and template data store 145 may provide a remote storage location for template chunks 65i-n.

In one exemplary approach, the split template biometric verification system 100 may operate across at least one computer network. The line between the template server 135 and the client 105 represents a generalized network connection. The network connection may be provided, for example, by a local area network (LAN), wide area network (WAN), or the Internet. The actual connection may be made by various transmission media including wires, wireless transmissions, and optical cables. Wireless transmissions may include or convey acoustic waves, light waves, and electromagnetic emissions, such as those generated during radio frequency (RF) and infrared (IR) data communications. Intervening networks and network devices, e.g. switches, routers, etc., that may be present in an implementation of the system 100 are omitted for simplicity of illustration. However, in another exemplary approach, local storage locations 70j-m, e.g., data storage unit 110, and card reader 127, may be used without the need for remote or network based storage, e.g., template data store 145.

The client 105 may be any general purpose computing device, such as a PC, or a specialized device. The client 105 may have software, such as an operating system with a network protocol stack, for establishing network connections to the template server 135. The operating system may include other software for accessing the data storage unit 110, biometric reader 125, and card reader 127. The client may include additional software such as the enrollment and verification module 130, configured to split the template 60 into multiple chunks 65i-n during enrollment and reconstitute the chunks during validation. The enrollment and verification module 130 and the template server 135 may communicate via a predefined communication protocol. For example, if the template server 135 is a web application server, the enrollment and verification module 130 may implement the Hyper Text Transfer Protocol (HTTP) to communicate therewith. While only one client 105 is illustrated in FIG. 1, multiple clients may be present in an actual implementation of the system 100. Moreover, the template server 135 may store a plurality of template chunks for the clients 105.

Data storage unit 110 may be any general purpose or specialty storage device such as a disk drive, an optical drive, a flash memory drive, etc. Data storage unit 110 may include a controller 120 and a storage medium 115. The connection between the data storage unit 110 and the client 105 may implement a data transmission bus. The client 105 may include a bus or host controller (not show) that connects via the bus to the controller 120. The controller 120 may regulate the storage and retrieval of data to and from the storage medium 115. The storage medium 115 may be a magnetic disk, an optical disc, or a solid state device. A solid state storage medium 115 may include flash memory such as NAND based electrically erasable programmable read-only memory (EEPROM). The controller 120 may implement a bus protocol such as the universal serial bus (USB), and more particularly the USB mass storage device class. The data storage unit 110 may provide one of many possible locations for storing one or more template chunks 65. For example, a chunk 65 could be stored on a removable flash drive based data storage unit 110. In one exemplary approach, the system 100 includes multiple data storage units 110 that may plug into the client 105. When plugged in, the enrollment and verification module 130 reassembles each of the chunks 65 into the template 60 and validates the template 60 against, for example, a live biometric sample, discussed in greater detail below. In this exemplary approach, the system 100 need not implement the template server 135 storing one or more of the chunks 65.

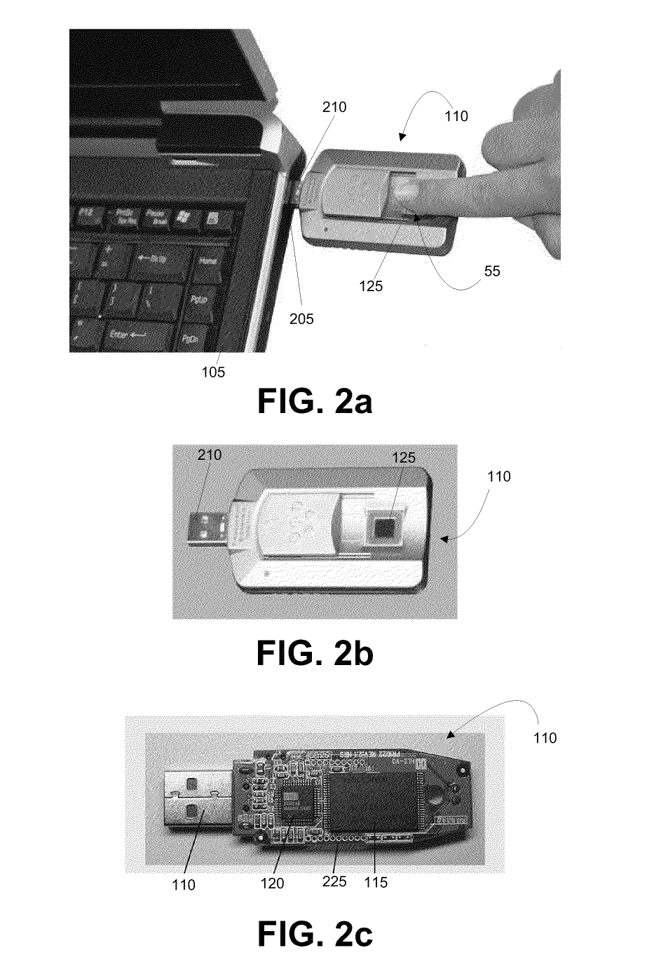

As discussed above, the biometric reader 125 may be used by client 105 for scanning a biometric identifier 55 of the user 107 as a credential, which may be used for authentication and verification purposes. As illustrated, the biometric reader 125 may be attached to the client 105 as a peripheral device. However, the biometric reader 125 may also be integrated with the client 105 or the data storage unit 110. For example, FIGS. 2a-b illustrate the biometric reader 125 integrated with a flash memory based data storage unit 110 that is removably attached to the client 105.

The card reader 127 may be a peripheral or embedded device configured to read data from removable cards. For example, a card may include a magnetic strip with encoded data stored thereon. The card reader 127 may include a read head configured to read the data encoded on the strip. Further, the card reader 127 may be configured to write new data to the card. In another exemplary approach, the removable card may be a smart card having a memory chip. The chip may have exposed contacts or leads for interfacing with the card reader. In another exemplary approach, the chip may be a Radio Frequency Identification (RFID) chip configured to interface with the card reader via radio frequency transmissions. Regardless of the particular technology of the card, the card reader 125 may be configured to read and write template chunks 165i-n to the card. In another exemplary approach, the data may be encoded as a bar code printed on the face of the card, and the card reader 127 may include a scanner for reading the bar code.

The template server 135 may be an application server such as a web application server. Application servers generally provide access to various facilities that combine programming logic, processing power, and data and file access. Web application servers may allow for access to computer program logic through an HTTP interface. Accordingly, web application servers typically provide an interface of procedures or functions, layered over top of HTTP, that may be called upon by remote computing devices, e.g. client 105. The client 105 may execute so-called remote procedure calls on the template server 135 or may initiate the procedures using a graphical web interface. Moreover, the remote device generally initiates the procedures on the template server 135 due to the nature of the underlying communication protocol. The template server 135 may communicate with the remote device, e.g. the client 105, in response to a specific request or remote procedure call. Functions and procedures to store and retrieve template chunks 65i-n may be provided by the template server 135. The template server 135 may further include additional software or programming logic outside of any remote procedures that is necessary to provide the template chunks 65i-n to the client 105. For example, the template server 135 may include instructions for accessing and manipulating the template data store 145.

The template data store 145 may be a relational database management system (RDBMS). Many such systems, including SQL Server, Oracle, and MySQL, among others, are generally available. The template data store 145 generally stores data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table.

FIG. 1c illustrates an exemplary chunk storage map 180. The chunk storage map 180 may provide mappings of chunks 65i-n to respective storage locations 70j-m. For example, when chunks 65i-n are stored to storage locations 70j-m, the enrollment and verification module 130 may create the chunk storage map 180. Recording the respective storage locations 70j-m of the chunks 65i-n may facilitate the reconstitution of the template 60. For example, the chunk storage map 180 may be used by the enrollment and verification module 130 for determining which storage location 70j-m holds particular chunks 65i-n. However, in another exemplary approach that always stores chunks 65i-n to the same locations 70j-m, the chunk storage map 180 may be omitted. If omitted, the user 107 may be responsible for manually reassembling the chunks 65 by, for example, providing the correct order of the chunks 65 into a software program. Alternatively, the user 107 may be responsible for loading the chunks 65 from multiple locations, such as data storage devices 110, for example, into the software in the correct order for reassembly.

The template 60 may be split into chunks 65i-n according to a variety of schemes. The chunk storage map 180 may also record the relationships between the chunks 65i-n and the template 60. To effectively reconstitute the template 60 from the chunks 65i-n, the scheme used to split the chunks may need to be recorded. For example, the relationships between the chunks 65i-n and the template 60 may include the order or respective positions of particular chunks within the template. The positions may be defined by delineations between the chunks 65i-n. The delineations may also be considered demarcations. For example, chunks 65i-n may be delineated according to certain amounts of data or byte lengths. In one exemplary approach, the delineations may be predetermined, e.g., always splitting the template 60 into 40 byte chunks 65i-n. Another exemplary predetermined delineation may divide the template 60 evenly in half. In a further exemplary approach, the delineations may be determined at the time of the dividing. For example, the delineations may be randomly determined. Regardless of the scheme, the chunk storage map 180 may record the relationships of the chunks 65i-n for later assembly into a reconstituted template 60.

FIGS. 2a-c illustrate exemplary data storage units 110. The data storage unit 110 may be a removable USB device that connects to a USB port 205 on the client 105. Such a data storage unit 110 is commonly referred to as a USB flash drive indicating that it includes a USB connector 210 and provides the storage medium 115 as solid state flash memory. The controller 120 of a USB based data storage unit 110 may implement the USB mass storage device protocol. The controller 120 and storage medium 115 may be included on and interconnected by a printed circuit board 225. The data storage unit 110 may be a storage location 70j-m for the template chunks 65i-n. As discussed above, the biometric reader 125 may be included with the data storage unit 110. For example, a fingerprint reader based biometric reader 125 may be configured to receive a scan of the biometric identifier 55, e.g., a fingerprint.

Computing devices such as template server 135, client 105, etc., may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device.

Computing devices such as template server 135, client 105, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer, a microcontroller, etc.). Such a medium may take many forms, including, but not limited to, non-volatile media and volatile medial. Non-volatile media may include, for example, optical or magnetic disks, read-only memory (ROM), and other persistent memory. Volatile media may include, for example, dynamic random access memory (DRAM), which typically constitutes a main memory. A transmission media may facilitate the processing of instructions by carrying instructions from one component or device to another. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The template data store 145 may include a query processor that employs Structured Query Language (SQL) in addition to a language for creating, storing, editing, and executing stored procedures, such as the Procedural Language/Structured Query Language (PL/SQL) utilized by Oracle, as mentioned above. The template data store 145 may be a type of database other than an RDBMS such as a hierarchical database, a set of files, an application database in a proprietary format, etc. The template data store 145 generally include a computing device employing a computer operating system such as one of those mentioned above, and is accessed via a network in any one or more of a variety of manners, as is well known.

FIG. 3 illustrates a flowchart of exemplary process 300 for enrolling a scan of a biometric identifier 55 as the template 60 that is split into chunks 65i-n. The client 105 may include a computer-readable medium having stored instructions for carrying out certain operations described herein, including some or all of the operations described with respect to process 300. For example, some or all of such instructions may be included in the enrollment and verification module 130. Process 300 is described as an interactive user processes. However, it is to be understood that automated or other types of programmatic techniques may implement the following steps.

The process 300 begins in step 305 when a reading or scan of a biometric identifier 55 may be accepted. The client 105 may activate the biometric reader 125 to scan the biometric identifier 55 presented by the user 107. The scan may result in a data file such as image data of the identifier 55.

Next, in step 310, the scan data from step 305 may be converted to the template 60. As discussed above, the raw data may be converted or reduced into a more convenient or useful form. For example, key details and points of the biometric identifier 55 may be mapped out into a mathematical representation which may be used for later comparisons.

Next, in step 315, the template 60 may be encrypted. Depending on the algorithm used to create the template, an analysis thereof may reveal sensitive details about the underlying biometric identifier 55. Accordingly, the template 60 may be encrypted to conceal any such identifiable details.

Next, in step 320, the template 60 may be split into chunks 65i-n. In one exemplary approach, the template 60 may be split evenly into two chunks 65i-n. However, other exemplary approaches may provide more elaborate splitting techniques. For example, a critical aspect of the template 60 may be spilt from the remainder. In another exemplary approach, the size of each chunk may be variable. Moreover, the size of the chunks 65i-n may be determined randomly at the time of the splitting. The relationship between a chunk 65i-n and the template 60 may be tracked to facilitate the reconstitution of the template 60. For example, the order of the chucks 65n-i with respect to each other may be used to reconstitute the template 60. Additionally, the delineations between the chunks 65i-n, e.g., the byte lengths of the chunks, may be tracked. In one exemplary approach, the delineations may provide the relationships and order of the chunks 65i-n.

Next, in step 325, the chunks 65i-n may be stored to the storage locations 70j-m. For example, chunk 65i may be stored to the data storage unit 110, while chunk 65n may be stored to the template server 135 and the template data store 140. In another exemplary approach, chunk 65i may be stored to a removable card using the card reader 127. In general, less than all of the chunks 65i-n may be stored to a first storage location 70j, e.g., the data storage unit 110, while the remaining chunks 65i-n may be stored to at least a second storage location 70m, e.g., the template data store 145. In one exemplary approach, each chunk 65i-n is stored in a different storage location 70j-m. However, in another exemplary approach, more than one chunk may be stored to the same location 70j, so long as at least one chunk is stored to a different location 70m. The location of each chunk 65i-n may be noted for later recording to the chunk storage map 180.

In step 330, if there are more chunks 65i-n remaining to be stored, the process may return to step 325. If there are no more chunks 65i-n remaining to be stored, the process may proceed to step 335.

In step 335, the chunk storage map 180 may be generated. As discussed above, the placement or ordering of the chunks 65i-n as well as the respective storage locations 70j-m may be tracked in steps 320 and 325. This information may then be written to the chunk storage map 180. The chunk storage map 180 may be used later to reconstitute the template 60. The chunk storage map 180 may be stored locally, e.g., on the data storage unit 110, or remotely on the template server 135 and template data store 145.

Following step 335, process 300 may end.

FIG. 4 illustrates a flowchart of exemplary process 400 for verifying a later scan of the biometric identifier 55 against the template 60. The client 105 may include a computer-readable medium having stored instructions for carrying out certain operations described herein, including some or all of the operations described with respect to process 400. For example, some or all of such instructions may be included in the enrollment and verification module 130. Process 400 is described as an interactive user processes. However, it is to be understood that automated or other types of programmatic techniques may implement the following steps.

The process 400 begins in step 405 when a reading or scan of a biometric identifier 55 may be accepted. This step may proceed in the same manner as step 305 above.

Next, in step 410, the chunk storage map 180 may be retrieved. For example, the chunk storage map 180 may be read from the data storage unit 110. The chunk storage map 180 may identify the locations 70j-m of the chunks 65i-n. The chunk storage map 180 may further identify the order in which the chunks 65i-n should be assembled to reconstitute the template 60.

Next, in step 415, a chunk 65i may be retrieved from storage location 70j. The mappings of the chunk storage map 180 may be iterated over to determine the location 70j. For example, the mapping may indicate that chunk 65i may be retrieved from the template data store 145 via the template server 135. The mapping may further include an identifier, path, or other attribute used to particularly locate the chunk 65i at the particular location 70j. If the chunk 65i is stored remotely, a network request, e.g., an HTTP request, may be generated and directed at the template server 135 according to the predetermined protocol thereof. If the chunk 65i is stored locally, the client 105 may interface with the controller 120 of the data storage unit 110 to retrieve the chunk from the storage medium 115. In another exemplary approach, the client 105 may operate the card reader 127 to read the chunk 65i from an inserted card.

In step 420, if there are more chunks 65i-n remaining to be retrieved, the process may return to step 415. If there are no more chunks 65i-n remaining to be retrieved, the process may proceed to step 425.

In step 425, the retrieved chunks 65i-n may be assessable to reconstitute the template 60. In one exemplary approach, the chunks 65i-n may be concatenated to reconstitute the template 60. The order of the concatenation may be based on orderings stored in the chunk storage map 180.

Next, in step 430, the reconstituted template 60 may be decrypted. As discussed above, the template 60 may be encrypted in step 315 prior to being split to provide a greater degree of protection to the sensitive data.

Next, in step 435, the scan of the biometric identifier from step 405 may be verified against the template 60. The scan may need to be transformed or converted into the same format of the template 60. Such a transformation process is described above in step 310. Once converted to common format, the data may be compared to see if there is a correspondence therebetween. In one exemplary approach, the scan may be verified based on an exact correspondence. However, in another exemplary approach, the scan may be verified based on the degree of correspondence exceeding a threshold. For example, a ninety percent correspondence may verify the scan.

Following step 435, process 400 may end.

Accordingly, exemplary systems and methods of split template biometric verification have been described. A biometric identifier 55 may be scanned and stored as a template 60 for later verification purposes. The template 60 may be split or divided into multiple chunks 65i-n to protect the sensitive nature of the data. As a further protection measure, the chunks 65i-n may be stored to different storage locations 70j-m. For example, the less than all of the chunks 65i-n may be stored to a first storage location 70j, while the remaining chunks may be stored to a second storage location 70m. A chunk storage map 180 may be used to identify the relationships between the template 60 and the chunks 65i-n as well as for recording the respective storage locations 70j-m of the chunks. The storage locations may include a local data storage unit, a removable data storage unit, a remote data store, a card with a magnetic strip, a smart card with a memory chip, etc.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A method comprising:
generating a template based upon an enrollment biometric identifier;
dividing the template into a plurality of chunks;
storing at least one of the plurality of chunks in a first storage location; and
storing at least another of the plurality of chunks in a second storage location.

2. A method as set forth in claim 1, further comprising generating a map linking each of the plurality of chunks to at least one of the first and second storage locations.

3. A method as set forth in claim 2, further comprising:
defining a scheme to reconstitute the template based on the plurality of chunks.

4. A method as set forth in claim 3, further comprising mapping relationships between the plurality of chunks and the template that includes at least the order of the plurality of chunks within the template.

5. A method as set forth in claim 4, further comprising mapping a relationship between the plurality of chunks relative to one another.

6. A method as set forth in claim 5, wherein the relationship between the plurality of chunks relative to one another is defined by a predetermined delineation.

7. A method as set forth in claim 6, wherein the predetermined delineation is a byte length.

8. A method as set forth in claim 5, wherein the relationship between the plurality of chunks relative to one another is randomly determined.

9. A method as set forth in claim 1, further comprising reconstituting the plurality of chunks into the template.

10. A method as set forth in claim 9, further comprising:
receiving a current biometric identifier; and
comparing the reconstituted template to the current biometric identifier.

11. A method as set forth in claim 1, wherein at least one of the first and second storage locations includes at least one of local data storage unit, a removable data storage unit, a remote data store, a printed bar code, a magnetic strip of a card, and a chip of a smart card.

12. A system comprising:
a plurality of storage devices storing at least one of a plurality of chunks of a template, a first chunk stored with respect to a first storage location and a second chunk stored with respect to a second storage location distinct from said first storage location; and
a client device in communication with said plurality of storage devices, wherein said client device includes a verification module configured to divide said template into said plurality of chunks and reconstitute said plurality of chunks into said template during validation.

13. A system as set forth in claim 12, wherein said plurality of storage devices includes a data storage unit having a controller and a storage medium, said controller being configured to regulate the storage and retrieval of data to and from said storage medium and said storage medium being configured to store at least one of said plurality of chunks of said template.

14. A system as set forth in claim 12, further comprising a biometric reader configured to receive biometric information.

15. A system as set forth in claim 14, wherein said verification module is configured to receive an enrollment biometric identifier from said biometric reader and convert said enrollment biometric enrollment identifier into said template.

16. A system as set forth in claim 15, wherein said verification module is configured to receive a current biometric identifier from said biometric reader.

17. A system as set forth in claim 16, wherein said verification module is configured compare said current biometric identifier to said template after said template has been reconstituted from said plurality of chunks.

18. A system as set forth in claim 12, wherein said plurality of storage devices includes a server in communication with said client device and configured to store at least one of said plurality of chunks of said template.

19. A system as set forth in claim 12, wherein said verification module is further configured to map a relationship between each of said plurality of chunks and said template.

20. A verification system comprising:
a plurality of storage devices including a data storage unit and a server, said data storage unit and said server each being configured to store at least one of a plurality of chunks of a template, a first chunk stored with respect to a first storage location and a second chunk stored with respect to a second storage location distinct from said first storage location;
a biometric reader configured to receive an enrollment biometric identifier from a user;
a client device in communication with said plurality of storage devices and said biometric reader, wherein said client device includes a verification module configured to generate said template based on said enrollment biometric identifier received from said biometric reader, divide said template into said plurality of chunks, map a relationship between each of said plurality of chunks and said template, and reconstitute said plurality of chunks into said template based on the relationship between each of said plurality of chunks and said template before validating the user.

21. A verification system as set forth in claim 20, wherein said verification module is configured to receive a current biometric identifier from said biometric reader and compare said current biometric identifier to said template after said template has been reconstituted from said plurality of chunks to validate the user.
